(19) United States
(12) Patent Application Publication
(10) Pub. No.: US 2006/0219295 A1
(43) Pub. Date: Oct. 5, 2006

(54) Method for filling water and device for filling water

(75) Inventors: Tetsuya Sakakibara, Toyohashi-city (JP); Noriyasu Kumaki, Tokyo (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); TO-OU KOGYO CO., LTD., Tokyo (JP)

(21) Appl. No.: 11/390,666

(22) Filed: Mar. 28, 2006

(30) Foreign Application Priority Data
Mar. 29, 2005 (JP) 2005-096077

(51) Int. Cl. F17D 1/00

(52) U.S. Cl. 137/2

(57) ABSTRACT

Highly-pure water is stored into a storage tank 46 by reducing an impurity-ion content to not greater than a specified rate by removing impurity ions via a device 43, for manufacturing pure water, containing ion-exchange resin, and by reducing a dissolved-oxygen content to not greater than a specified rate by heating-deaerating with a heater 44 and reducing the pressure during storage in the storage tank 46. Highly-pure water to be stored is injected from a gun 10 into a vessel body 1 while detecting a flow-rate via a mass-flow meter 53. Therefore, a highly-accurate amount of water, with high purity, can be filled into the vessel body 1.

### BACKGROUND OF THE INVENTION

1. Field of the Invention

The present invention relates to a method of filling water, and to a device for filling water, to quantitatively fill highly-pure water into a closed vessel.

2. Description of the Related Art

As a prior art, there is a method of filling water disclosed in Japanese unexamined patent publication No. 2000-274855. The method of filling water is a method of filling cooling-water into a stirling cooler, wherein a circulating channel for cooling water is filled with the cooling water.

Concretely, disconnected end portions of circulating-channel piping are submerged into a water tank, and a circulating pump is operated until air bubbles are not released from the end portions. After that, the end portions are connected together in the water and a specified amount of water, which fills the inside of the circulating-channel, is filled into the circulating channel.

In recent years, a device which fills water into a part of a space in a closed vessel has been desired. The device utilizes a heat flow accompanied by vaporization or condensation of the water, or heat flow accompanied by adsorbing or desorbing the water, to cool a heat-generating element or a heat-generating device.

Inventors of the present inventions found that the amount and the purity of water to be filled are important when water is filled into a closed vessel constituting these devices.

For example, in a device which allows a heat flow accompanied by vaporization or condensation of the water, when the amount of water is not appropriate, a balance between vaporization and condensation of the water is not good, and it is difficult to fully demonstrate a cooling performance. It was found that when the purity of the water to be filled is low, in other words, when an amount of impurity is great, the cooling performances are worsened because the inside surfaces, and the like, of the closed vessel are corroded by the impurity and the balance between vaporization and condensation of the water is worsened by gas components and the like formed during the corrosion.

It is impossible to fill a determined amount of water without filling it into the closed vessel, even if the above-described conventional method of filling water is employed. Further, it is difficult to maintain a purity of water to be filled at a high level, because the filling of the water is carried out in an opened state.

Therefore, considering the above-mentioned points, the inventors wholeheartedly studied the problem and conceived of the present invention of a method of filling water, whereby it is possible to maintain the purity of the water at a high level, and to fill water in a highly accurate amount, and a device for filling water utilizing this method.

### SUMMARY OF THE INVENTION

The purpose of the present invention is to provide a method of filling water and a device for filling water, whereby it is possible to fill a highly accurate amount of highly-pure water.

In order to achieve the above-described purpose, the method of filling water of the present invention of claim 1 is

a method of filling a specified amount of highly-pure water, of which an impurity-ion content is not greater than a specified rate and a dissolved-oxygen content is not greater than a specified rate, into a vessel body (1) which can form a closed structure, characterized by comprising

a storing step (46, 200) of storing water, of which the impurity-ion content is not greater than the specified rate, under a reduced pressure atmosphere so that the dissolved-oxygen content becomes not greater than the specified rate, and

an injecting step (300) of injecting a specified mass of water stored at the storing step (46, 200) into the vessel body (1).

Thereby, the dissolved-oxygen content can be decreased to not greater than the specified rate, by reducing the pressure, when water, of which the impurity-ion content is not greater than the specified rate, is stored at the storing step (46, 200).

Further, it is possible to fill a highly-accurate amount of highly-pure water into the vessel body (1), by injecting a specified mass of water stored into the vessel body (1) at the storing step (46, 200) in the injecting step (300).

A method of filling water of the present invention of claim 2 is characterized by further comprising

a water-refining step (43, 200) of refining water by using at least an ion-exchange resin so that the impurity-ion content becomes not greater than a specified rate,

wherein at the storing step (46, 200), water refined at the water-refining step (43, 200) is stored.

Thereby, water, of which the impurity-ion content was decreased to not greater than a specified rate by removing impurity ions at the water-refining step (43, 200), can be stored at the storing step (46, 200).

A method of filling water of the present invention of claim 3 is characterized by further comprising a heating-deaerating step (44, 200) of heating water refined at the water-refining step (43, 200) to remove dissolved oxygen, after the water-refining step (43, 200) and before the storing step (46, 200).

Thereby, it is possible to easily remove dissolved oxygen of the water before it is stored at the storing step (46, 200) in the heating-deaerating step (44, 200), and surely degrease the dissolved-oxygen content of the water stored at the storing step (46, 200) to not greater than a specified rate.

A method of filling water of the present invention of claim 4 is characterized in that, in the storing step (46, 200), the reduced-pressure atmosphere is adjusted based on the dissolved-oxygen content in the water to be stored.

Thereby, the dissolved-oxygen content of the water to be stored at the storing step (46, 200) can be surely maintained at not greater than a specified rate.

A method of filling water of the present invention of claim 5 is characterized in that, in the storing step (46, 200), it is judged, based on the electrical conductivity of the water to be stored, whether the injecting step (300) should be carried out or not.

Thereby, when the impurity-ion content of the water to be stored at the storing step (46, 200) increased, and electrical conductivity thereof increased, the injecting step (300) can be stopped. As a result, injecting water with low purity can be prevented at the injecting step (300).

A method of filling water of the present invention of claim 6 is characterized by further comprising a nitrogen-purging step (320) of passing nitrogen gas into a water-supplying channel (11) for supplying the specified amount of water at the injecting step (300) to remove water which remains in the water-supplying channel (11), after the injecting step (300) and before the next injecting step (300) is carried out.

Thereby, the accuracy of the amount of water injected at a next injecting step (300) can be increased, bar removing water remained in the water-supplying channel (11). Because of the purging with nitrogen gas, it also can be prevented that the dissolved-oxygen content of water to be stored at the next injecting step (300) increases.

A device for filling a specified amount of highly-pure water, of which an impurity-ion content is not greater than a specified rate, and a dissolved-oxygen content is not greater than a specified rate, into a vessel body (1) which can form a closed structure, characterized by comprising

a storage tank (46) for storing water, of which the impurity-ion content is not greater than a specified rate, under a reduced pressure atmosphere so that the dissolved-oxygen content becomes not greater than a specified rate,

connecting-injecting means (10) for connecting with the vessel body (1), and injecting water stored in the storage tank (46) into the vessel body (1), and

mass-flow-rate detecting means (53) for detecting a mass-flow rate of water to be supplied from the storage tank (46) to the connecting-injecting means (10).

Thereby, a method of filling water according to claim 1 can be performed.

Therefore, it is possible to decrease the dissolved-oxygen content to not greater than a specified rate, by reducing the pressure, when water of which the impurity-ion content is not greater than a specified rate is stored in the storage tank (46), and inject only a specified mass of water stored in the storage tank (46) into the vessel body (1) from the connecting-injecting means (10). According to this method, a highly-accurate amount of highly-pure water can be filled into the vessel body (1).

A device for filling water of the present invention of claim 8 is characterized by further comprising

water-refining means (43) containing an ion-exchange resin for removing the impurity ions from water to decrease the impurity-ion content to not greater than a specified rate,

wherein the storage tank (46) stores water of which the impurity-ion content was decreased to not greater than a specified rate by the water-refining means (43).

Thereby, the method of filling water according to claim 2 can be performed.

Consequently, water of which the impurity-ion content was decreased to not greater than a specified rate by removing the impurity-ion through the water-refining means (43) can be stored in the storage tank (46).

A device for filling water of the present invention of claim 9 is characterized by further comprising heating-deaerating means (44) for heating water refined by the water-refining means (43) to remove dissolved oxygen, in a channel whereby water refined by the water-refining means (43) is conveyed from the water-refining means (43) to the storage tank (46).

Thereby, the method of filling water according to claim 3 can be performed.

Therefore, it is possible to easily remove dissolved oxygen from the water before it is stored in the storage tank (46) at the heating-deaerating means (44), and surely allow the dissolved-oxygen content of the water to be stored at the storage tank (46) to be not greater than a specified rate.

A device for filling water of the present intention of claim 10 is characterized by further comprising dissolved-oxygen content detecting means (463), installed in the storage tank (46), for detecting the dissolved-oxygen content of water to be stored in the storage tank (46), wherein the reduced-pressure atmosphere in the storage tank is adjusted based on detected values of the dissolved-oxygen content detecting means (463).

Thereby, the method of filling water according to claim 4 can be performed.

Consequently, the dissolved-oxygen content of the water to be stored in the storage tank (46) can be surely maintained at not greater than a specified rate.

A device for filling water of the present invention of claim 11 is characterized by further comprising electrical-conductivity detecting means (464), installed in the storage tank (46), for detecting the electrical conductivity of the water to be stored in the storage tank (46), wherein the supply of the water from the storage tank (46) to the connecting-injecting means (10), and stopping the supply of water are chanced over based on the detected values from the electrical-conductivity detecting means (464).

Thereby, the method of filling water according to claim 5 can be performed.

Therefore, when the impurity-ion content of the water to be stored in the storage tank (46) is increased and electrical conductivity thereof is increased, injecting water from the connecting-injecting means (10) into the vessel body (1) can be stopped. As a result, injecting water with low purity into the vessel body (1) can be prevented.

A device for filling Water of the present invention of claim 12 is characterized bag further comprising nitrogen-purging means (13, 60) for passing nitrogen gas into a water-supplying channel (11), for supplying water into the vessel body (1), of the connecting-injecting means (10).

Thereby, the method of filling water according to claim 6 can be performed.

Therefore, the accuracy of the amount of water to be injected from the connecting-injecting means (10) into the vessel body (1) the next time can be increased, by removing water which remained in the water-supplying channel (11) of the connecting-injecting means (10). Further, it also can be prevented that the dissolved-oxygen content of water during the next injecting period increases, because the inside of the water-supplying channel (11) is purged with nitrogen gas.

A code inside parentheses attached to each above-described means is one example demonstrating a corresponding relation with concrete means described in the embodiments explained hereafter.

### BRIEF DESCRIPTION OF THE DRAWINGS

FIG. 1 is a drawing to illustrate a schematic configuration showing a rough constitution of a device for filling water in one embodiment where the present invention is applied.

FIG. 2 is a flowchart to illustrate kinds of controlling which a controlling device 100 performs.

FIG. 3 is a flowchart to illustrate a flow of operations of a filling step including manual operations.

FIG. 4 is a flowchart to illustrate controlling operations of a controlling device 100 during controlling filling and controlling nitrogen purge (controlling a filling step).

FIG. 5 is a time-chart to illustrate controlling operations of filling and nitrogen-purging of a controlling device 100.

FIG. 6 is a drawing to illustrate an operating state of a device for filling water at a refining-storing controlling step of a controlling device 100.

FIG. 7 is a drawing to illustrate an operating state of a device for filling water at a gun-evacuating controlling step of a controlling device 100.

FIG. 8 is a drawing to illustrate an operating state of a device for filling water at a product-evacuating controlling step of a controlling device 100.

FIG. 9 is a drawing to illustrate an operating state of a device for filling water at a controlling step for checking degree of vacuum of a controlling device 100.

FIG. 10 is a drawing to illustrate an operating state of a device for filling water at a filling-timing controlling step of a controlling device 100.

FIG. 11 is a dragging to illustrate an operating state of a device for filling water at a controlling step for filling pure water of a controlling device 100.

FIG. 12 is a drawing to illustrate an operating state of a device for filling water at a fill-complete timing controlling step of a controlling device 100.

FIG. 13 is a drawing to illustrate an operating state of a device for filling water at a nitrogen-purging controlling step of a controlling device 100.

### DETAILED DESCRIPTION OF THE INVENTION

Embodiments according to the present invention are further explained based on Figures, as follows.

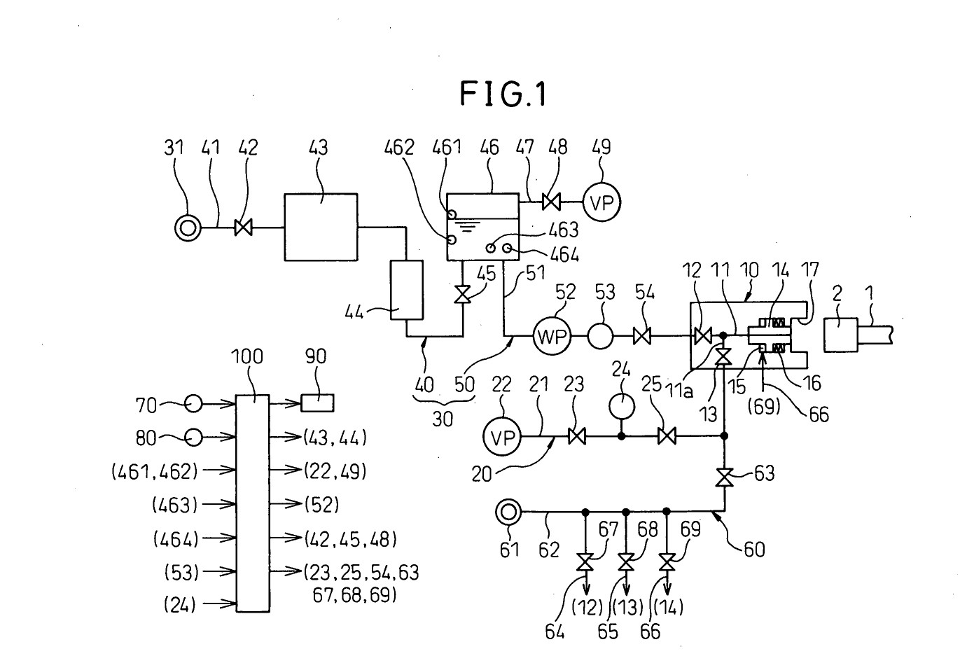

FIG. 1 is a drawing of a schematic configuration showing a rough constitution of a device for filling water in one embodiment where the present invention is applied

The device for filling water of this Embodiment is a device for filling water into the vessel body 1 (showing only a part (an injecting-pipe portion)), wherein the vessel body 1 is, for example, a boiling-cooling device, for filling water as a coolant into a part of an internal space.

As shown in FIG. 1, the device for filling water of this Embodiment comprises a coupler 2 installed to the injecting-pipe end portion of the vessel body 1, and a charging gun (hereafter referred to as a gun) 10 which is connecting-injecting means for injecting water into the vessel body 1.

An exhausting system 20 for reducing the pressure inside of the gun 10 and the vessel body 1, and producing an approximate vacuum, a water-supplying system 30 for supplying water to be injected into the vessel body 1 via the gun 10, and a nitrogen-supplying system 60 for supplying nitrogen gas into the gun 10 are connected to this gun 10.

A water-supplying channel 11 is formed in the gun 10, and a valve (a water valve) 12 opening or closing this water-supplying channel 11 is installed in close to the left end of the water-supplying channel 11 (an upstream end), shown in FIG. 1, in the gun 10.

The right end of the water-supplying channel 11 (a downstream end), shown in FIG. 1, opens at the inside of a mounting portion 17 for mounting the coupler 2 installed to the vessel body 1. This mounting portion 17 is a coupler portion forming a configuration corresponding to the coupler 2, and the gun 10 comprises a stem valve 14 movable forward and backward inside the mounting portion 17.

A portion in close to the right end of the water-supplying channel 11 (close to the downstream end), as shown in FIG. 1, is formed in the stem valve 14, and the right end of the water-supplying channel 11 (the downstream end), shown in FIG. 1, opens at a portion close to the tip end of the stem valve 14 in the mounting portion 17.

When the stem valve 14 approaches into the mounting portion 17 where the coupler 2 was mounted, a tip portion of the stem valve 14 depresses a fill body (not shown in FIG. 1) installed in the coupler 2, and the water-supplying channel 11 and the inside of the vessel body 1 are connected. When the stem valve 14 moves from the inside of the mounting portion 17, the tip portion of the stem valve 14 leaves from the fill body of the coupler 2, and the fill body shuts the inside of the vessel body 1 against the water-supplying channel 11.

At the inside of the gun 10, the water-supplying channel 11 joins a channel 11a in close to the valve 12. This channel 11a is a channel for allowing the water-supplying channel 11 to communicate with the exhausting system 20 and the nitrogen-supplying system 60, and a valve (a vacuum valve) 13 for opening or closing this channel is installed.

All of the valve (a water valve) 12, the valve (a vacuum valve) 13 and the stem valve 14, installed in the gun 10, are pressure-operating valves. When pressure was applied to a pressure chamber (not shown in FIG. 1) according to operations of the hereafter-described valves 67 and 68, the valves 12 and 1; allow each channel to open. When the pressure of the pressure chamber was released, the valves 12 and 13 allow each channel to close through an energizing force of a spring material (not shown in FIG. 1).

When pressure was applied to a pressure chamber 15 according to operations of the hereafter-described valve 69, the stem valve 14 approaches the mounting portion 17. When the pressure of the pressure chamber 15 was released, the stem valve 14 moves from the inside of the mounting portion 17 due to an energizing force of a spring (a spring material) 16.

At the left end of the water-supplying channel 11 (an upstream end) of the gun 10, shown in FIG. 1, the water-supplying system 30 is connected. The water-supplying system 30 is composed of a refining-storing portion 40 for refining and storing tap water supplied from a tap-water feed throat 31, and a quantitatively-supplying portion 50 for supplying a determined amount of refined water which is stored through the gun 10.

The refining-storing portion 40 comprises a closed storage tank 46 made of metal (stainless steal in this Example) for storing the refined water.

The tap-water feed throat 31 and the storage tank 46 are connected through a piping 41. At the piping 41, a valve 42, which allows a channel of this piping 41 to open or close, is installed in close to the tap-water feed throat 31.

In the channel of the piping 41 at a downstream side of the valve 42, a device 43 for manufacturing pure water, which is water-refining means for refining tap water supplied from the feed throat 31 to this channel, is installed. The device 43 for manufacturing pure water comprises a membrane material which can remove organic fine particles, bacteria and the like, and an ion-exchange resin for removing impurity ions. The device reduces tap water to water of which the impurity-ion content is not greater than a specified rate (so-called pure water).

At a downstream side of the device 43 in the channel of the piping 41, a heater 44 is installed as heating-deaerating means for heating water, of which impurity ions were removed by the pure-water manufacturing device, to remove gas components such as oxygen dissolved in the water.

At a downstream side of the heater 44 in the channel of the piping 41, a valve 45 which allows a channel of the piping 41 to open or close is installed in close to the storage tank 46.

At internal areas of side walls of the storage tank 46, plural level sensors for detecting a level of water stored in the storage tank 46 are installed in a vertical direction. A level sensor 461 positioned at the highest portion of these plural level sensors is upper-limit-level detecting means, and a level sensor 462 positioned at the lowest portion is lower-limit-level detecting means. In other words, the level of water to be stored in the storage tank 46 can be maintained between both level sensors 461 and 462.

The level sensors 461, 462 and the like are arranged to output information of the water level in the storage tank 46 to the hereafter-described controlling device 100.

At a portion higher than the level sensor 461 of the storage tank 46, one end of piping 47 is connected. A vacuum pump 49 is installed at another end of the piping 47. At the piping 47 which connects the upper space over a water surface of the storage tank 46 and the vacuum pump 49, a valve 48 allowing this channel to open or close is installed.

At a portion lower than the level sensor 462 of the storage tank 46, a dissolved-oxygen sensor 463 which is dissolved-oxygen-content detecting means for detecting the dissolved-oxygen content of water stored in the storage tank 46, and an electrical-conductivity meter 464 which is electrical-conductivity detecting means for detecting electrical conductivity of water stored in the storage tank 46, are installed.

The dissolved-oxygen sensor 463 outputs information of the dissolved-oxygen content of water stored in the storage tank 46, and the electrical-conductivity meter 464 outputs information of the electrical conductivity of, water stored in the storage tank 46, to the hereafter-described controlling device 100.

On the other hand, the quantitatively-supplying portion 50, constituting the water-supplying system 30 together with the refining-storing portion 40, comprises a piping 51 connecting the storage tank 46 and the gun 10. One end (an upstream end) of the piping 51 is connected to the lower surface portion of the storage tank 46, and the other end (a downstream end) is connected to an upstream end of the water-supplying channel 11 of the gun 10.

At this piping 51, a water pump 52 for conveying water of the storage tank 46 toward the gun 10 is installed. At a downstream side of the water pump 52 in a channel of the piping 51, a mass-flow meter 53 is installed as mass-flow-rate detecting means for detecting a mass-flow rate of water to be supplied to the gun 10 through the piping 51.

The mass-flow meter 53 is arranged to output information of the mass-flow rate of water, which is supplied from the storage tank 46 to the gun 10 through the piping 51, to the hereafter-described controlling device 100.

A valve 54, which allows the channel of the piping 51 to open or close, is installed at a downstream side of the mass-flow meter 5, in a channel of the piping 51.

The exhausting system 20 is connected to the lower end of the channel 11a of the gun 10 (an end opposite to a side of a joining point with the water-supplying channel 11), shown in FIG. 1.

The exhausting system 20 has piping 21, where one end is connected to the channel 11a of the gun 10 and a vacuum pump 22 is installed at the other end. Two valves 23 and 25, which allow the channel of the piping 21 to open or close, are installed in this piping 21.

In the piping 21, a vacuum indicator (vacuum-degree detecting means and pressure detecting means) 24 for detecting a degree of vacuum of the inside of the piping 21 is installed between the valves 23 and 25.

The vacuum indicator 24 is arranged to output information of the decree of vacuum in the piping 21 to the hereafter-described controlling device 100.

At the piping 21, the nitrogen-supplying system 60 is connected in a branching form between a portion where the valve 25 (one of two valves, which is installed at a side of the gun 10) is installed and a joining point with the channel 11a of the gun 10.

The nitrogen-supplying system 60 has a piping 62 connecting between a nitrogen-feed throat 61 and the joining point with the piping 21, and comprises a valve 63 which allows the channel of the piping 62 to open or close in close to the joining point with the piping 21

At the piping 62, pressure-applying piping 64, 65 and 66 for applying nitrogen-gas pressure to each of pressure chambers of each of valves 12, 13 and 14 in the gun 10 (omitting to show valves 12 and 13 in FIG. 1, and showing the pressure chamber 15 for the stem valve 14) are connected between the nitrogen-feed throat 61 and the valve 63.

At each of the pressure-applying piping 64, 65 and 66, valves 67, 68 and 69 are installed in order to switch a mode of applying pressure in the piping 62 to the pressure chamber of each of valves 12, 13 and 14, and a mode of shutting out transmitting pressure from the piping 62 to the pressure chamber of each of valves 12, 13 and 14 to release pressure of each pressure chamber to the atmosphere.

In this Example, these valves 67, 68 and 69 are solenoid valves comprising an electromagnetic solenoid and a spring. They are arranged to form the mode of applying pressure during turning-on the electricity (a period of an “On” state), and the mode of shutting off pressure and releasing pressure to the atmosphere during turning off the electricity (a period of an “Off” state).

These valves 67, 68 and 69 are not limited to the solenoid valise, if they can perform such a switching operation. Although the above-mentioned valves 23, 25 42, 45, 48, 54 and 63 are solenoid valves comprising an electromagnetic solenoid and a spring in this Example, they may also be valves operated by other driving forces.

A controlling device 100 which is controlling means is constituted so that information of the level of water is inputted from the level sensors 461 and 462, information of the dissolved-oxygen content is inputted from the dissolved-oxygen sensor 463, information of the electrical-conductivity is inputted from the electrical-conductivity meter 464, information of the mass-flow rate is inputted from the mass-flow meter 53, and information to the degree of vacuum is inputted from the vacuum indicator 24.

The controlling device 100 is constituted so that when a starting switch 70 is turned on, or a purging switch 80 is turned on, information such as the state is inputted from each of the switches 70 and 80.

Further, the controlling de-ice 100 is constituted to output signals for controlling operations of the device 43 for manufacturing pure water, the heater 44, the vacuum pumps 22 and 49, the water pump 52, the valves 42, 4S and 48 and the valves 23, 25, 54, 63, 67, 65 and 69, based on the above-mentioned information according to the hereafter-described procedures. The controlling device 100 also is arranged to output an operating signal to an alarming portion 90 which is alarming means.

Then, a method of filling water utilizing the device for filling water of this Embodiment is explained as follows, based on the above-mentioned constitutions.

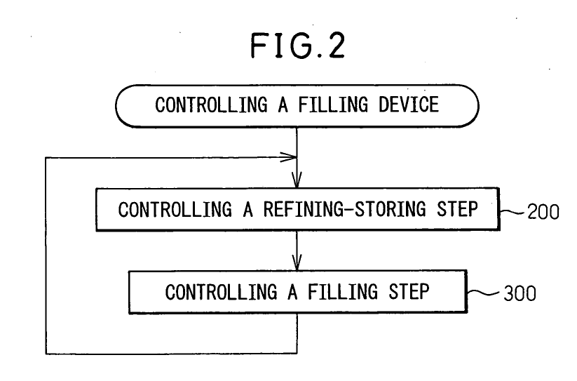

The controlling device 100 of the device for filling water in this Embodiment carries out as appropriate, as shown in FIG. 2, control for a refining-storing step of refining tap water and storing it as highly-pure water (Step 200) and control for a step of filling the refined and stored highly-pure water into a vessel body 1 (Step 300).

The controlling of the refining-storing step at Step 200 is carried out before performing filling-step control at Step 300, or during performing the filling-step control, and controls the operations of each constitution of the refining-storing portion 40.

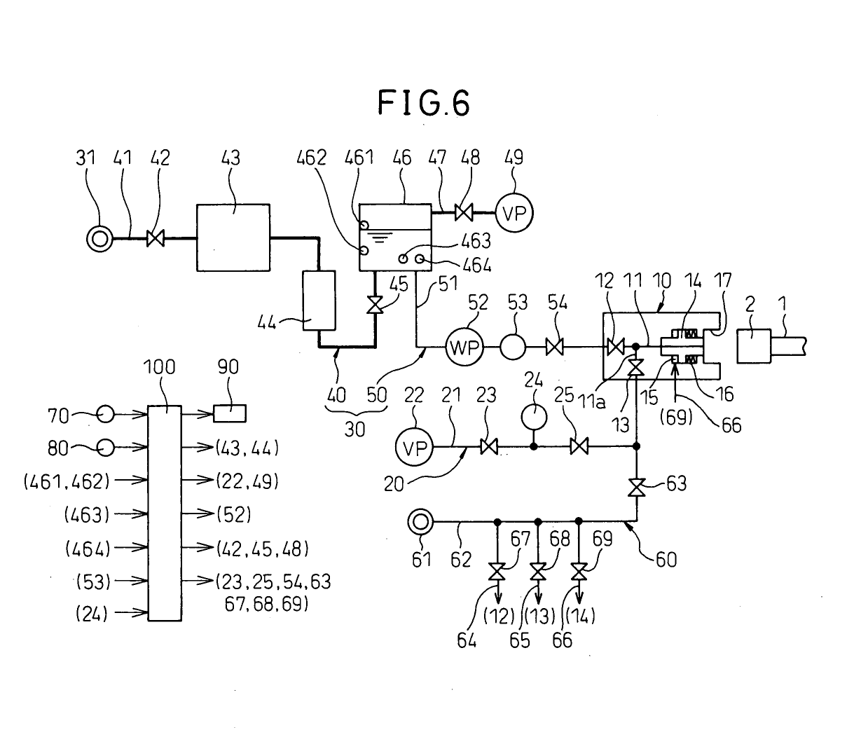

Concretely, as shown in FIG. 6, the controlling device 100 opens the valves 42 and 45, and operates the device 43 for manufacturing pure water and the heater 44. Thereby, impurity ions in tap water supplied from the tap-water feed throat 31 are removed by the device for manufacturing pure water. The water becomes one in which the impurity-ion content is not greater than a specified rate, and is conveyed to the heater 44.

Water of which the impurity-ion content is not greater than a specified rate is heated and deaerated by the heater 44, whereby dissolved oxygen is separated as oxygen gas. Then, water, which was heated and deaerated, and of which the dissolved-oxygen content is not greater than a specified rate, is introduced into the storage tank 46.

This control operation is carried out based on the water level detected by the level sensors 461 and 462. It is starred when the water level of the storage tank 46 becomes lower than the level sensor 462 which is lower-limit-level detecting means, and is stopped when the water level reaches the level sensor 461 which is upper-limit-level detecting means.

Therefore, highly-pure water where the impurity-ion content is not greater than a specified rate, and the dissolved-oxygen content is not greater than a specified rate, is stored in the storage tank 46 so that the water level is between the level sensor 461 and the level sensor 462.

The controlling device 100 monitors quality of water in the storage tank 46 via the dissolved-oxygen sensor 463 and the electrical-conductivity meter 464.

When the dissolved-oxygen content of the stored water exceeded (or is about to exceed) the specified rate (for example 1 ppm), the vacuum pump 49 is operated, and the valve 48 is opened. Thereby, pressure inside of the storage tank 46 is reduced, and dissolved oxygen is removed from water in the storage tank 46. In such a manner, the dissolved-oxygen content of water in the storage tank 46 is kept to be not greater than a specified amount.

When it is judged that a detected value of the electrical-conductivity meter 464 is greater than the electrical conductivity (for example 100 μS/m) of water containing impurity ions at the specified rate, the filling-step controlling at Step 300 is prohibited, and an alarm demonstrating that the impurity-ion content exceeds the specified rate is issued at the alarming portion 90.

Then, the filling-step controlling of Step 300 is explained.

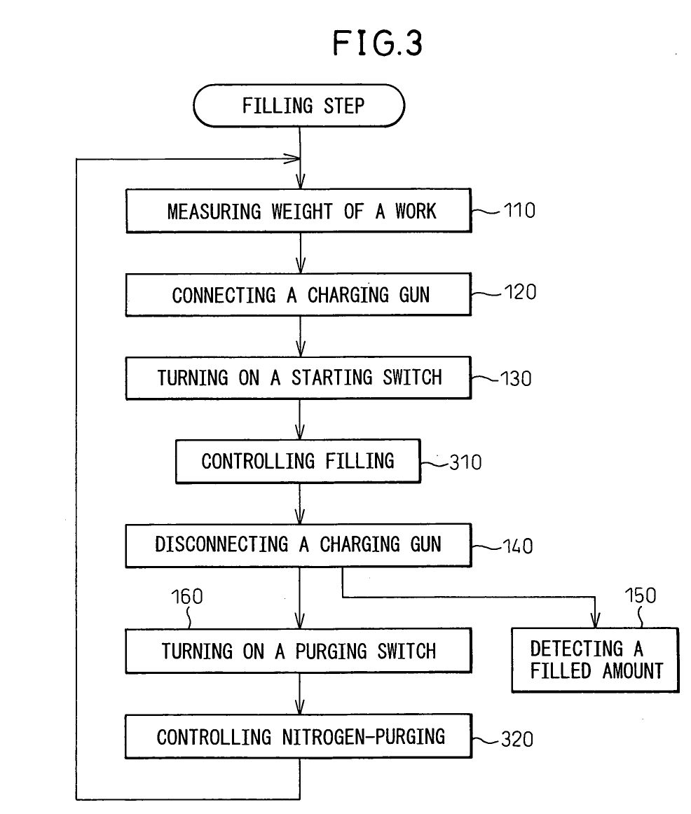

This filling-step controlling comprises filling control (Step 310) and nitrogen-purging control (Step 320), which the controlling device 100 performs, in an operation flow of the filling step for filling highly-pure water into the vessel body 1 shown in FIG. 3. Before explaining the filling control and the nitrogen-purging control which the controlling device 100 performs, the operation flow of the filling step, including manual operations shown in FIG. 3, is explained.

As shown in FIG. 1, when the filling step is carried cut, an operator initially measures the weight of the vessel body (a work) 1 (Step 110), and carries out operation for subtracting tare weight for measuring a filled amount. Then, the operator connects the mounting portion 17 of the gun 10 with the coupler 2 of the vessel body 1 (Step 120). Further, the operator turns on the starring switch 70 (Step 130).

By turning on the starting switch 70, the controlling device 100 performs the filling controlling (Step 310), then after completing it, notifies completion of the filling controlling to the operator via notifying means such as a chime.

The operator who received this notice carries out disconnecting the gun 10 and the vessel body 1 (Step 140), and examines the filled amount by detecting weight of the vessel body 1 in which water was filled (Step 150). Further, the purging switch 80 is turned on (Step 160).

By turning on the purging switch 80, the controlling device 100 performs a nitrogen-purging controlling (Step 320). Then, the operation is retuned to Step 110.

Detecting of the amount of highly-pure water filled into the vessel body 1 may be a method where an operator performs detecting with a measuring device and judges, or a manner where an operator adjusts a measuring apparatus, and the measuring apparatus judges. A method where an automatic measuring means is installed in the device for filling water, also may be utilized.

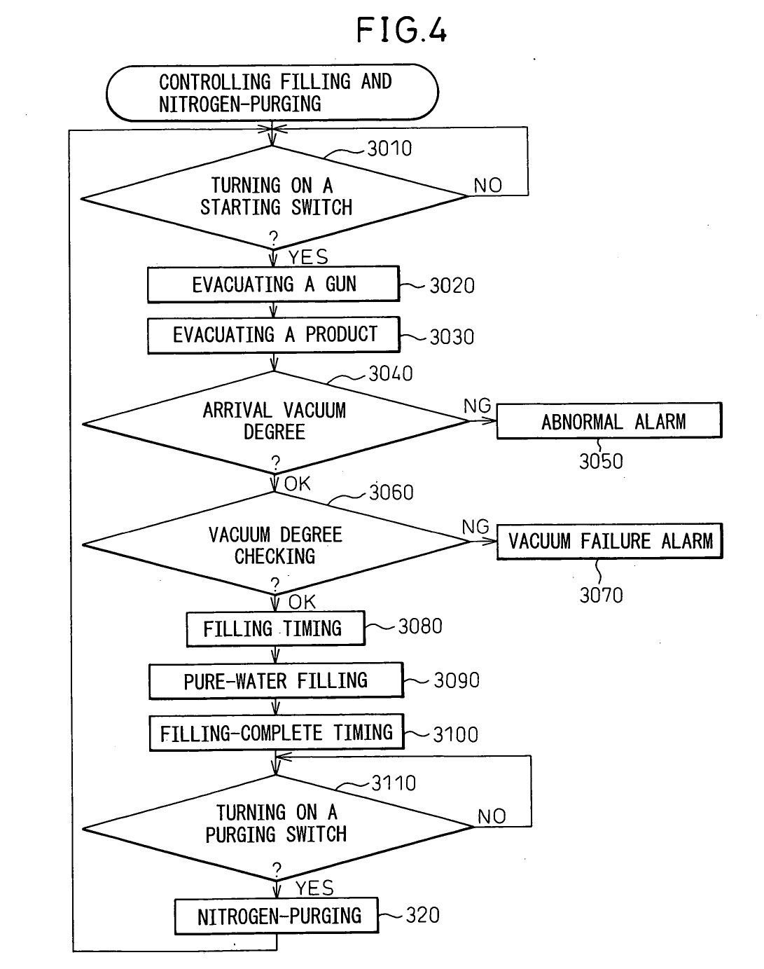

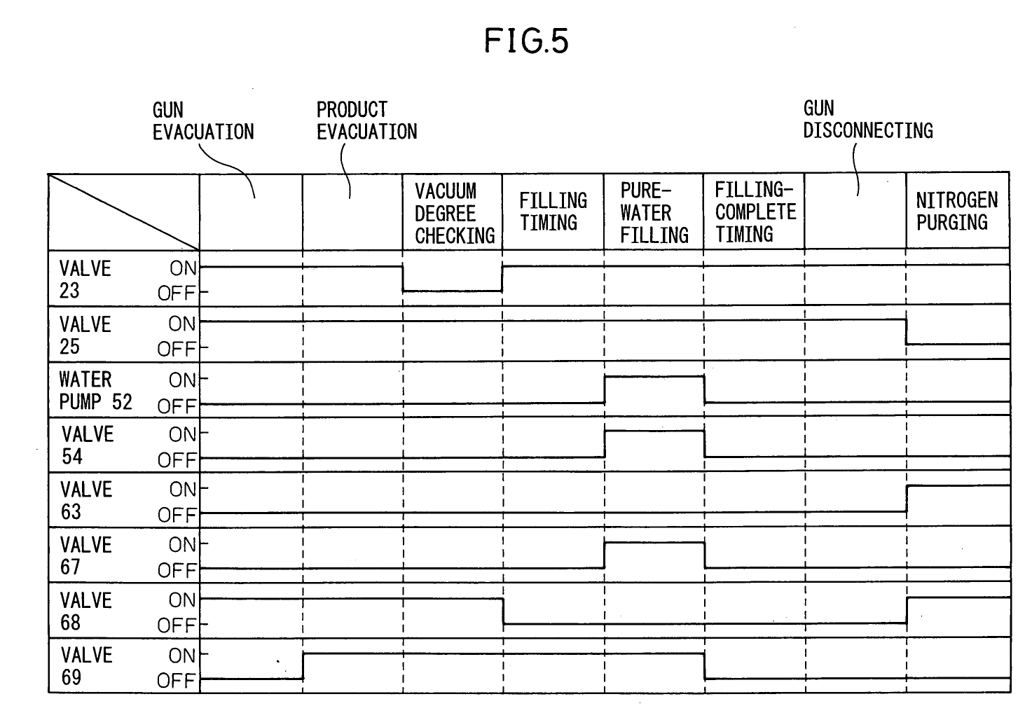

Then, controlling operations of the controlling device 100 at the filling controlling (Step 310) and the nitrogen-purging controlling (Step 320) is explained. FIG. 4 is a flowchart to illustrate controlling operations or the controlling device 100 during controlling filling and controlling nitrogen purge. FIG. 5 is a time-chart to illustrate the controlling operations.

In FIG. 5, the states “On” and “Off” of the valves 23, 25, 54, 63, 67, 68 and 69, and the states “On” and “Off” of the water pump 52 for the filling controlling and the nitrogen-purging controlling are demonstrated, however operations of the constitution of the refining-storing portion 40 are not described. The vacuum pump 22, which is always in a state of “On” while an electric source is introduced to the filling device, is also omitted in FIG. 5

As shown in FIG. 4, the controlling device 100 monitors whether the starting switch 70 is turned on or not (Step 3010), and goes on to Step 3020 when it judged that the starting switch 70 was turned on. In Step 3020, evacuating the inside of the water-supplying channel 11 of the gun 10 (gun-evacuating) is carried out.

As shown in FIG. 5, when gun-evacuating is carried out, the controlling device 100 forms a mode of applying pressure by allowing the valves 23 and 25 to turn on and open, and allowing the valve 68 to turn on, and opens the valve 13. Other valves are turned off.

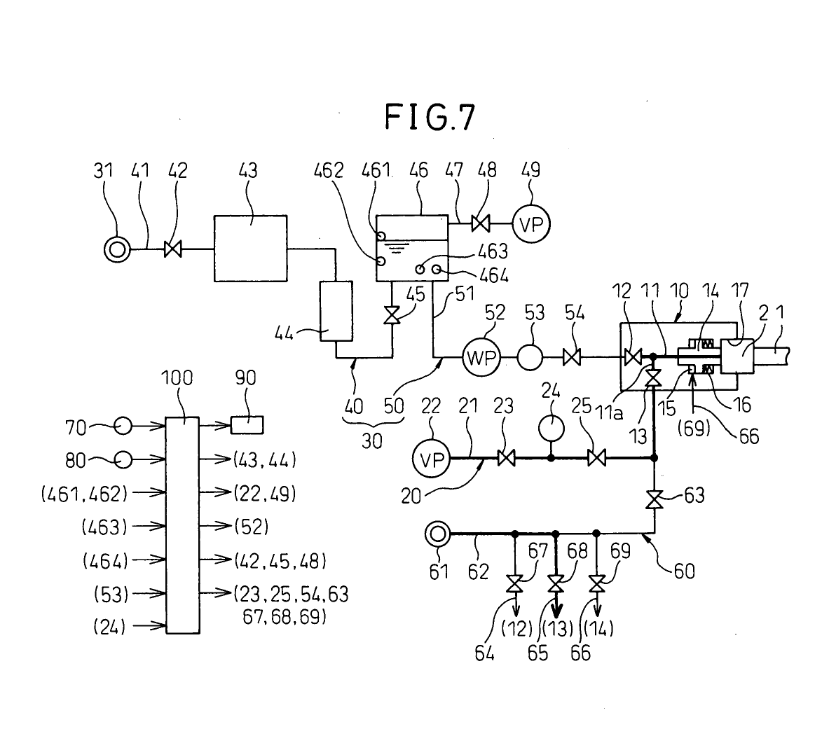

Thereby, as shown in FIG. 7, the water-supplying channel 11 of the gun 10 is evacuated through the piping 21, and the inside of the water-supplying channel 11 becomes in a vacuum state. At this moment, the coupler 2 has been mounted to the mounting portion 17 of the gun 0, and the filling structure is formed between the gun 10 and the coupler 2.

The controlling device 100 evacuates the gun for a determined period, and then performs evacuating the inside of the vessel body 1 (Step 3030).

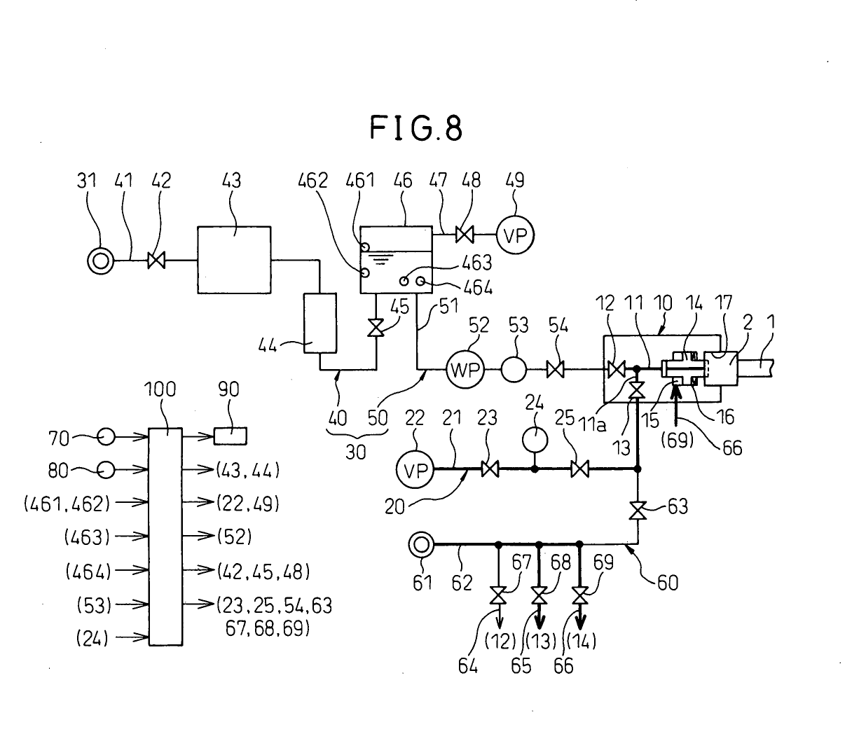

As shown in FIG. 5, when it is carried out to evacuate the inside of a product, the controlling device 100 forms, for a gun-evacuating state, a mode of applying pressure by allowing the valve 69 to turn on to allow the stem valve 14 to go forward to the right side, as shown in the Figure, and depresses a filling body (not shown in Figure) of the coupler 2 from a tip portion squeezed. Thereby, as shown in FIG. 8, evacuating also is carried out from the inside of the vessel body 1 communicated with the water-supplying channel 11, and the inside of the vessel body 1 also becomes a vacuum.

The controlling device 100 evacuates the inside of the product for a determined period, and then checks the degree of vacuum of the inside of the vessel body 11 and the inside of the water-supplying channel 11 (Steps 3040 and 3060).

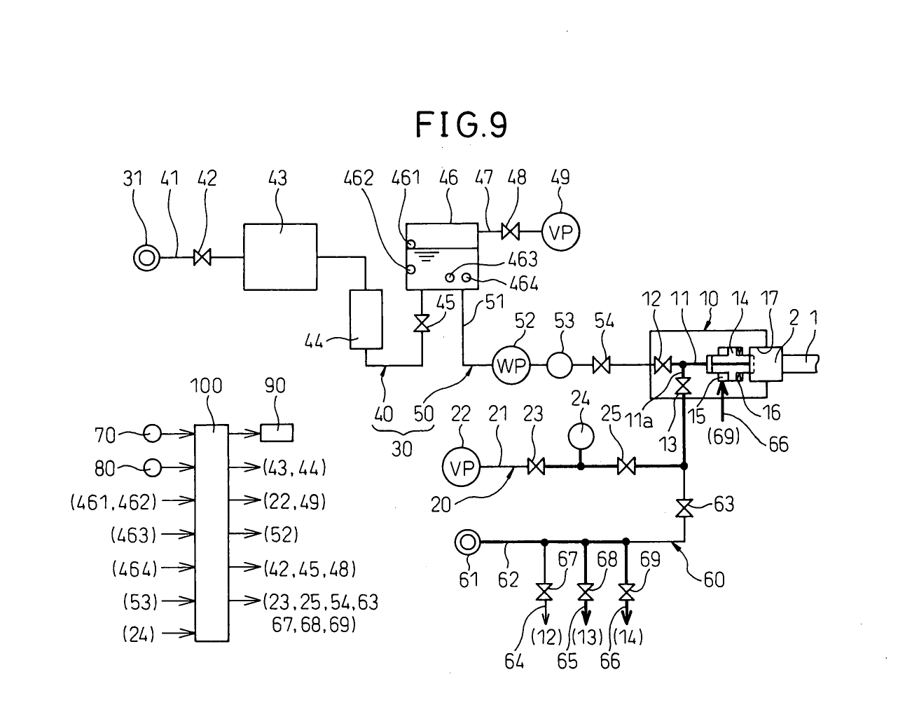

As shown in FIG. 5, when it is carried out to check a degree of vacuum, the controlling device 100 allows the valve 23 to turn off and close, for a state of evacuating a product. Further, as shown in FIG. 9, the controlling device 100 judges a reaching-degree of vacuum of the inside of the vessel body 1 and the inside of the water-supplying channel 11, based on information from the vacuum indicator 24 which is shut out from the vacuum pump 22, and communicated with the water-supplying channel 11 (Step 3040). When a specified degree of vacuum was not reached, an alarm is issued by operating the alarm portion 90 (Step 3050).

When it was judged that the specified degree of vacuum was reached at Step 3040, the controlling device 100 judges whether the degree of vacuum can be maintained or not (Step 3060). In other words, when pressure variation per time is not less than a specified value, it is determined that there is poor filling and the like and the degree of vacuum cannot be maintained, and then a poor-filling alarm is issued by operating the alarm portion 90 (Step 3070).

When it was judged that the degree of vacuum could be maintained at Step 3060, a filling-timing state is set (Step 3080). The filling-timing state is set during a short period as a state for preparing to inject highly-pure water into the vessel body 1.

As shown in FIG. 5, when the filling-timing state is set, the controlling device 100 turns on the valve 23 and allows it to open again, turns off the valve 68 and shuts out pressure, and enters the mode for releasing to the atmosphere and closes the valve 13, to check the degree of vacuum.

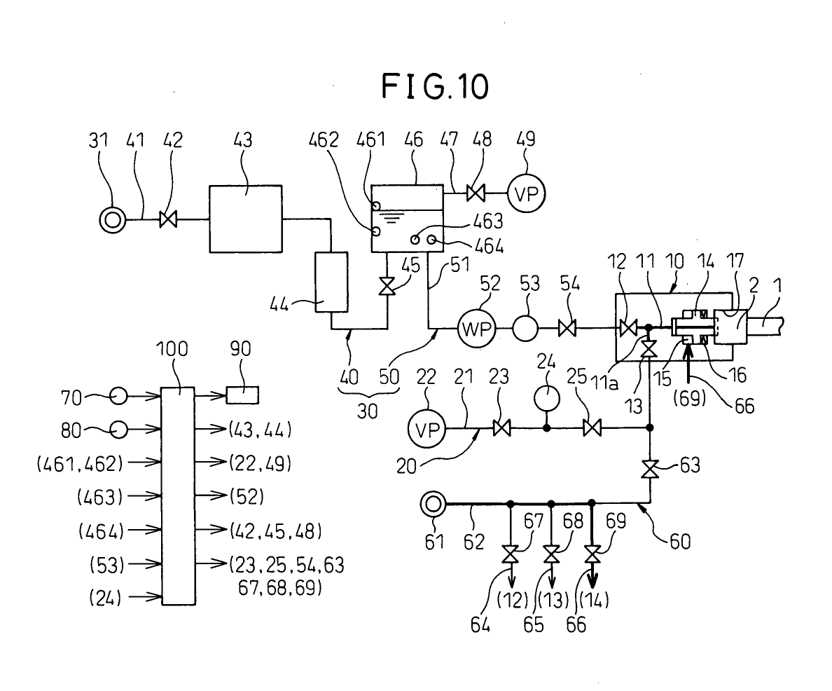

Thereby, as shown in FIG. 10, while the water-supplying channel 11 of the gun 10 and the vessel body 1 are maintained in the vacuum state, they are shut of from each of the systems 20, 30 and 60.

When the controlling device 100 sets the filling-timing state, the highly-pure water is injected (felled) into the vessel body 1 (Step 3090).

As shown in FIG. 5, when the pure water is filled, the controlling device 100 turns on the water pump 52 and the valve 54 and allows the valve 54 to open, in the filling-timing state. Further, the controlling device 100 turns on the valve 67, forms the mode of applying pressure, and allows the valve 12 to open.

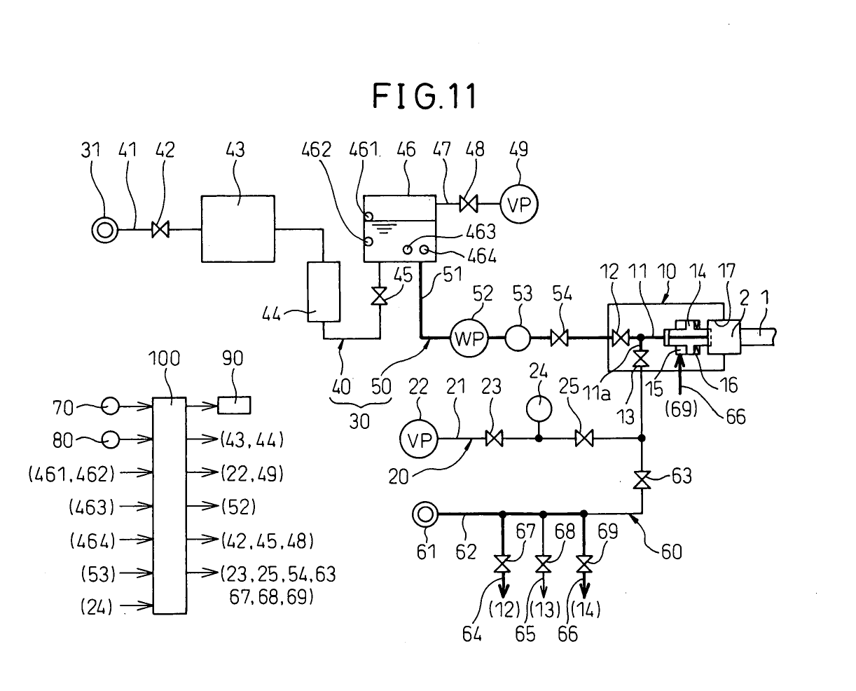

Thereby, as shown in FIG. 11, the highly-pure water in the storage tank 46 is injected into the vessel body 1 through the piping 51 and the water-supplying channel 11. At this time, the controlling device 100 monitors an injected amount of the highly-pure water based on the information of a flow rate from the mass-flow meter 53, and goes forward to next Step 3100 to a state of fill-complete timing, at the time when it is judged that a specified mass of the highly-pure water was injected (concretely, the time when it is judged that a mass to be injected into the vessel body 1 and a mass to remain in the water-supplying channel 11 after completing injecting had flowed).

After the state of fill-complete timing was set, the controlling device 100 turns off the water pump 52 and the valve 54 and allows the valve 54 to close, in the pure-water filling state. The controlling device 100 turns off the valve 67, and enters the mode of shutting off pressure and releasing pressure to the atmosphere to allow the valve 12 to close. Further, the controlling device 100 turns off the valve 69 and enters the mode of shutting off pressure and releasing pressure to the atmosphere to allow the stem valve 14 to move toward the left side, as shown in FIG. 11. Then, it disconnects the tip portion of the coupler 2 from a filling body (not shown in Figure), and stops depressing the filling body.

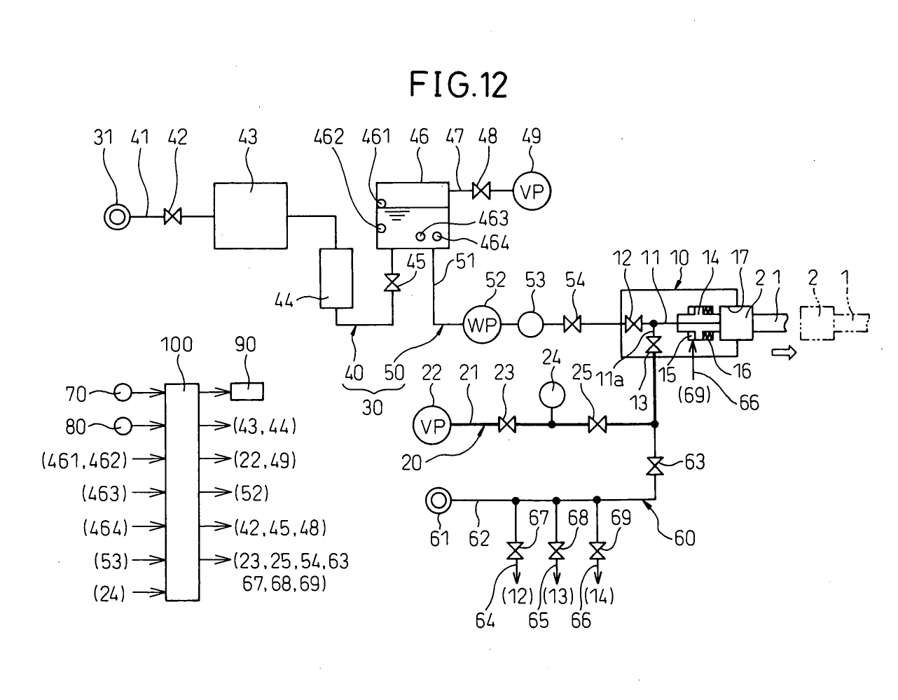

Thereby, as shown in FIG. 12, the inside of the vessel body 1 is shut out from the water-supplying channel 11, and the highly-pure water infected into the vessel body 1 is filled. Finally, an injecting pipe of the vessel body 1 is filled and cut, and the highly-pure water is completely filled into the vessel body 1.

Although not shown in FIG. 4, after when the controlling device 100 sets the state of fill-complete timing, it is informed to an operator via notifying means such as a chime that the filling was completed, as described before.

Herein, the notified operator allows the coupler 2 of the vessel body 1 to manually disconnect from the mounting portion 17 of the gun 10, as shown with a chain double-dashed line in FIG. 12. At this time, a part of the highly-pure water filled in the water-supplying channel 11 of the gun 10 is discharged outside from the mounting portion 17, and the rest remains in the water-supplying channel 11.

After the controlling device 100 sets the state of fill-complete timing, and notifies via the notifying means that the filling was completed, the controlling device 100 monitors whether the purging switch 80 was turned on or not (Step 3110). When it was judged that the purging switch 30 was turned on, the controlling device 100 goes forward to Step 320. At Step 320, nitrogen flows into the water-supplying channel 11.

As shown in FIG. 5, when nitrogen-purging is performed, the controlling device 100 turns off the valve 25 to allow it to close, and turns on the valve 63 to allow it to open. Further, it turns on the valve 68, and forms the mode of applying pressure to open the valve 13.

In other words, as shown in FIG. 12, at the state of fill-complete timing, although the exhausting system 20 was connected with the channel 11a joining to the water-supplying channel 11, the inside of the water-supplying channel 11 was in a state where pressure could riot be reduced, due to a closed state of the valve 13.

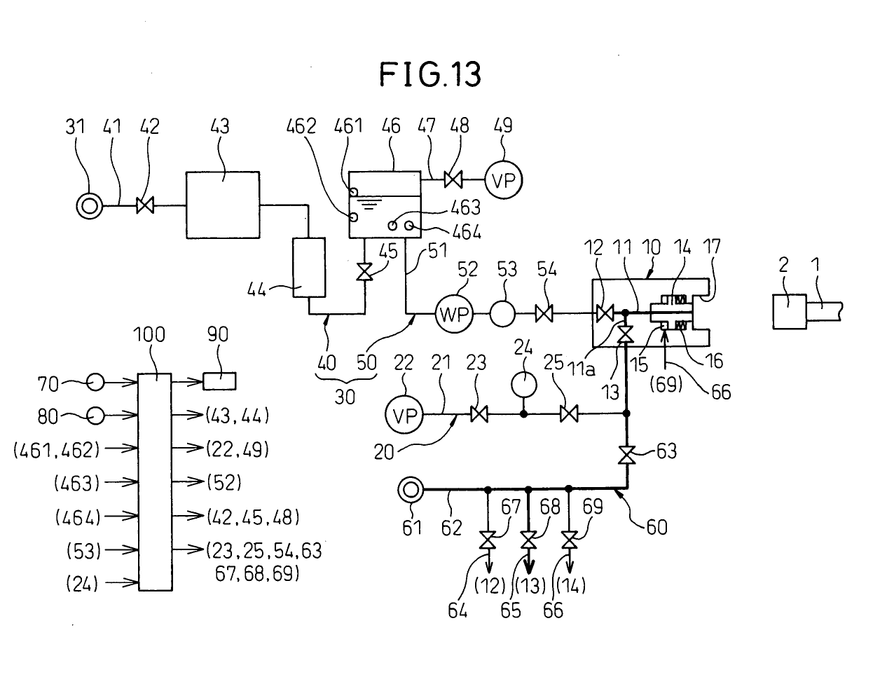

On the other hand, after when Step 320 was performed, as shown in FIG. 13, the state is changed to one where the nitrogen-supplying system 60 is connected with the channel 11a joining to the water-supplying channel 11, and the valve 13 allows the channel 11a to open. Therefore, nitrogen gas supplied from the nitrogen-feed throat 61 through the piping 62 is purged into the water-supplying channel 11.

Accompanied by this nitrogen-purging, the highly-pure water in the water-supplying channel 11 is discharged from the right end (the downstream end) of the water-supplying channel 11, shown in FIG. 13.

A constitution composed of the nitrogen-supplying system 60 and the valve 13 may be the nitrogen-purging means in this Embodiment.

After the controlling device 100 has carried out nitrogen-purging controlling at Step 320, it returns to Step 3010.

Herein, the step of refining tap water in the device 43 for manufacturing sure water shown in FIG. 6, through controlling the refining-storing step shown in FIG. 2, is the water-refining step in this Embodiment. The step of heating-deaerating the refined water at the heater 44 shown in FIG. 6, through controlling the refining-storing step shown in FIG. 2, is the heating-deaerating step in this Embodiment.

The step of storing in a reduced-pressure atmosphere the highly-pure water refined in the storage tank 46 shown in FIG. 6, through controlling the refining-storing step shown in FIG. 2, is the storing step in this Embodiment The step of injecting a specified amount of water into the vessel body 1 from the gun 10 via the mass-flow meter 53 as shown in FIG. 11, through controlling the refining-storing step shown in FIG. 2, is the injecting step in this Embodiment.

The step of purging nitrogen into the water-supplying channel 11 of the gun 10 as shown in FIG. 13, through performing nitrogen-purging controlling shown in FIG. 4, is the nitrogen-purging step in this Embodiment.

For making easily understandable, in FIGS. 6-13, the main channels where fluids flow, or pressure is reduced according to operations, are shown with a bold solid line. Channels which are not relating to operations are shown without a bold solid line, even if pressure is increased or decreased.

According to the above-mentioned constitutions and operations, it is possible that highly-pure water, where the impurity-ion content was decreased to not greater than a specified rate by removing impurity ions via the device for manufacturing pure water containing ion-exchange resin, and the dissolved-oxygen content was decreased to not greater than a specified rate by heating-deaerating with the heater 44 and reducing pressure during storing in the storage tank 46, can be injected into the vessel body 1 from the gun 10 while detecting its flow rate with the mass-flow meter 53. Therefore, it is possible to fill highly-pure water into the vessel body 1 in a highly accurate amount.

When highly-pure water is stored in the storage tank 46, it can be prevented that water with higher dissolved-oxygen content than a specified rate (a specified value) is injected into the vessel body 1, by monitoring the dissolved-oxygen content with the dissolved-oxygen sensor 463, and decreasing the dissolved-oxygen content by further reducing pressure in the storage tank 46 as appropriate.

When highly-pure water is stored in the storage tank 46, it can be prevented that water with higher impurity-ion content than a specified rate is injected into the vessel body 1, by monitoring an electrical conductivity, which can be an index of the impurity-ion content, with the electrical-conductivity meter 464, and prohibiting the step for injecting water into the vessel body 1 when the electrical conductivity corresponds to a case where the impurity-ion content is higher than a specified rate (a specified value).

After injecting highly-pure water into the vessel body 1, and before performing the next injection, water in the gun 10 is discharged outside by nitrogen-purging. Thereby, the accuracy of the injected amount of highly-pure water at the next injecting period can be improved. Due to being purged with nitrogen, it also can be prevented that the dissolved-oxygen content of water at the next infecting period increases.

In this manner, it is possible to surely fill a specified amount of highly-pure water, where both of the impurity-ion content and the dissolved-oxygen content were decreased to not greater than a specified rate, into the vessel body 1 constituting a boiling-cooling device. Therefore, the vessel body 1 can surely demonstrate a performance as a cooling device, and can maintain the performances as the cooling device for a long period by inhibiting corrosion of the vessel body 1.

Each of the valves 12, 13 and 14 installed in the gun 10 is a pressure-operating valve which is operated with or without application of nitrogen-gas pressure. Therefore, miniaturization and weight reduction of the gun 10 are easy, as each of the valves 12, 13 and 14 is not a valve having a driving source like, for example, a solenoid valve. Maintenances is also very easy, as maintenance work for of each of the valves 12, 13 and 14 can be mainly carried out at the sides of the valves 67, 68 and 69 for adjusting the state of pressure-applying for each of the valves 12, 13 and 14.

The pressure applied to each of the valves 12, 13 and 14 utilizes nitrogen-gas pressure of the nitrogen-supplying system 60 which is utilized for nitrogen-purging. Therefore, the system can be relatively simplified, since it is not necessary to arrange another pressing-gas system.

### Other Embodiments

For highly-pure water to be stored in the storage tank 46 in the above-mentioned Embodiment, the dissolved-oxygen content was reduced by heating and deaerated with the heater 44 in advance; and a state of low dissolved-oxygen content in the highly-pure water was maintained by reducing pressure in the storage tank 46. However, if it is possible to make the highly-pure water in a state of the low dissolved-oxygen content only by reducing pressure in the storage tank 46, the heating-deaerating step is not always necessary.

Although each of the valves 12, 13 and 14 installed in the gun 10 was a pressure-operating valve in the above-mentioned Embodiment, it is not limited to the pressure-operating valve. A valve having a driving source like, for example, a solenoid valve also may be utilized.

In the above-mentioned Embodiment, a device 43 for manufacturing pure water as water-refining means was installed in the refining-storing portion 40. However, a device without the device 43 for manufacturing pure water may be utilized, if water, of which the impurity-ion content was reduced to not greater than a specified rate, can be stored in the storage tank 46.

For example, a device for directly supplying water, which was refined by other refining plant and the like so that an imparity-ion content becomes not greater than a specified rate, in the storage tank 46 (a manner where the water refining step and the heating-deaerating step are omitted from the above-mentioned Embodiment) may be utilized. A device for heating-deaerating water, which was refined by other refining plant and the like so that an impurity-ion content becomes not greater than a specified rate, by the heater 44, and supplying it in the storage tank 46 (a manner where the water refining step is omitted from the above-mentioned Embodiment) also may be utilized.

In the above-mentioned Embodiment, n example was explained where the vessel body 1 was the boiling-cooling device. A vessel body can be effectively utilized in the present invention, if it is a vessel body for filling a specified amount of highly-pure water.

The method of filling water of the present invention may comprise steps of preparing pure water, preparing a vessel, measuring the weight of the pure water to be filled into the vessel, injecting the pure water into the vessel, and then sealing the vessel. Both of a case where pure water is injected into the vessel by leaving a part of the space in a vessel, and a case where pure water is injected into a vessel so that the vessel becomes full of the pure water may be included in the method of filling water of the present invention.

What is claimed is:

1. A method of filling a specified amount of highly-pure water, of which an impurity-ion content is not greater than a specified rate, and a dissolved-oxygen content is not greater than a specified rate, into a vessel body (1) which can form a closed structure, characterized by comprising
a storing step (46, 200) of storing water, of which the impurity-ion content is not greater than the specified rate, under a reduced pressure atmosphere so that the dissolved-oxygen content becomes not greater than the specified rate, and
an injecting step (300) of injecting a specified mass of water stored at the storing step (46, 200) into the vessel body (1).

2. The method of filling water according to claim 1, characterized by further comprising a water-refining step (43, 200) of refining water by using at least an ion-exchange resin so that the impurity-ion content becomes not greater than a specified rate,
wherein at the storing step (46, 200), water refined at the water-refining step (43, 200) is stored.

3. The method of filling water according to claim 2, characterized by further comprising a heating-deaerating step (44, 200) of heating water refined at the water-refining step (43, 200) to remove dissolved oxygen, after the water-refining step (43, 200) and before the storing step (46, 200).

4. The method of filling water according to claim 1, characterized in that, in the storing step (46, 200), the reduced-pressure atmosphere is adjusted based on the dissolved-oxygen content in the water to be stored.

5. The method of filling water according to claim 1, characterized in that, in the storing step (46, 200), it is judged, based on the electrical conductivity of the water to be stored, whether the injecting step (300) should be carried out or not.

6. The method of filling water according to claim 1, characterized by further comprising a nitrogen-purging step (320) of passing nitrogen gas into a water-supplying channel (11) for supplying the specified amount of water at the injecting step (300) to remove water which remains in the water-supplying channel (11), after the injecting step (300) and before the time when a next injecting step (300) is carried out.

7. A device for filling a specified amount of highly-pure water, of which an impurity-ion content is not greater than a specified rate, and a dissolved-oxygen content is not greater than a specified rate, into a vessel body (1) which can form a closed structure, characterized by comprising
a storage tank (46) for storing water, of which the impurity-ion content is not greater than a specified rate, under a reduced pressure atmosphere so that the dissolved-oxygen content becomes not greater than a specified rate,
connecting-injecting means (10) for connecting with the vessel body (1), and injecting water stored in the storage tank (46) into the vessel body (1), and
mass-flow-rate detecting means (53) for detecting a mass-flow rate of water to be supplied from the storage tank (46) to the connecting-injecting means (10).

8. The device for filling water according to claim 7, characterized by further comprising water-refining means (43) containing an ion-exchange resin for removing the impurity ions from water to decrease the impurity-ion content to not greater than a specified rate,
wherein the storage tank (46) stores water of which the impurity-ion content was decreased to not greater than a specified rate by the water-refining means (43).

9. The device for filling water according to claim 8, characterized by further comprising heating-deaerating means (44) for heating water refined by the water-refining means (43) to remove dissolved oxygen, in a channel whereby water refined by the water-refining means (43) is conveyed from the water-refining means (43) to the storage tank (4E).

10. The device for filling water according to claim 7, characterized by further comprising dissolved-oxygen content detecting means (463), installed in the storage tank (46), for detecting the dissolved-oxygen content of water to be stored in the storage tank (46),
wherein the reduced-pressure atmosphere in the storage tank is adjusted based on detected values of the dissolved-oxygen content detecting means (463).

11. The device for filling water according to claim 7, characterized by further comprising electrical-conductivity detecting means (464), installed in the storage tank (46), for detecting the electrical conductivity of the water to be stored in the storage tank (46),
wherein supplying water from the storage tank (46) to the connecting-injecting means (10), and stopping supplying water are changed-over based on the detected values from the electrical-conductivity detecting means (464).

12. The device for filling water according to claim 7, characterized by further comprising nitrogen-purging means (13, 60) for passing nitrogen gas into a water-supplying channel (11), for supplying water into the vessel body (1), of the connecting-injecting means (10).
